(19) United States
(12) Patent Application Publication
(10) Pub. No.: US 2014/0372928 A1
(43) Pub. Date: Dec. 18, 2014

(54) COMMON DASHBOARD FRAMEWORK FOR CREATING A MASHUP DASHBOARD

(71) Applicant: Software AG USA Inc., Reston, VA (US)

(72) Inventors: Daniel Malks, Arlington, VA (US); Karthic Thope, Fairfax, VA (US); John Crupi, Bethesda, MD (US)

(21) Appl. No.: 14/301,880

(22) Filed: Jun. 11, 2014

Related U.S. Application Data
(60) Provisional application No. 61/834,199, filed on Jun. 12, 2013.

(51) Int. Cl. G06F 3/0481; G06F 3/0484

(52) U.S. Cl. CPC G06F 3/0481; G06F 3/04847
USPC 715/771

(57) ABSTRACT

A common dashboard framework includes dashboard configuration data that specifies a configuration of dashboard content and a user interface configuration for a mashup dashboard. The dashboard content and the user interface configuration control visual and behavioral characteristics of the mashup dashboard that are independent of mashup data, and that are controlled to provide a same look and feel for different mashups. Different dashboard configuration data provides a different look and feel for the different mashups. The dashboard module data specifies whether the mashup dashboard is associated with a group of mashup dashboards. If so, the mashup dashboard further reflects the pre-defined group of mashup dashboards. The apparatus assembles the mashup dashboard based on the dashboard configuration data, the dashboard module data, and a workspace for the mashup data.

### CROSS-REFERENCE TO RELATED APPLICATIONS

This application claims the benefit of U.S. Provisional Application No. 61/834,199 filed on Jun. 12, 2013, all of which is expressly incorporated herein by reference.

### TECHNICAL FIELD

The technical field relates to interface design, and more specifically to mashup dashboard design using a common, customizable dashboard framework.

### BACKGROUND

In the context of computer management systems, a “dashboard” is an easy-to-read, often single-page, real-time user interface showing a graphical representation of the current status or snapshot of various data, including for example, historical trends and performance indicators. A dashboard facilitates informed decision making. A business that uses software to manage its information may seek to use a variety of dashboard displays to meet the varied and evolving needs of its internal divisions as well as of its customers. Such businesses seek tools to easily deploy dashboards in a quicker and more customized fashion.

Typically, dashboards purchased by business customers, such as information technology divisions of corporate entities or even individual consumers, are unable to vary the visualization or display configuration of a purchased dashboard to meet specific internal and external customer needs. Thus a framework that would allow for a dynamic modification and/or adjustment of a dashboard would certainly provide an economic benefit to the dashboard users. As well, the information provided by a modified dashboard is likely to be more relevant and instructive to the dashboard users.

### SUMMARY

Accordingly, one or more embodiments disclosed herein provide an apparatus that includes a memory and a processor. The processor is cooperatively operable with the memory. The processor is programmed to execute steps.

Specifically, the processor is programmed to provide a common dashboard framework. The common dashboard framework includes dashboard configuration data and dashboard module data. The dashboard configuration data specifies a configuration of dashboard content and a user interface configuration for a mashup dashboard. The dashboard content and the user interface configuration control visual and behavioral characteristics of the mashup dashboard that are independent of mashup data.

The visual and behavioral characteristics are controlled to provide a same look and feel for different mashups. More generally stated, the visual and behavioral characteristics are controlled to provide similar characteristics for different mashups. Of course, the same look and feel, and/or similar characteristics, for different mashups affect intended focus by users, promote or facilitate a consistent interpretative approach, and aid in common usability.

A different dashboard configuration data provides a different look and feel for the different mashups. The dashboard module data specifies whether the mashup dashboard is associated with a pre-defined group of mashup dashboards. When the mashup dashboard is associated with the pre-defined group of mashup dashboards, a configuration of the mashup dashboard further reflects the pre-defined group of mashup dashboards.

Lastly, the processor is programmed to assemble the mashup dashboard based on the dashboard configuration data, the dashboard module data, and a workspace for the mashup data. The processor then provides a dashboard for delivery and presentation to a user.

A further embodiment disclosed herein relates to a method that includes the action described above in the disclosed apparatus. As well, a non-transitory computer readable storage medium is disclosed that stores instructions such that the corresponding method is executed by a computer.

The purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating an overview of the dashboard assembly process using a common dashboard framework application.

FIG. 2 is a screenshot of an example dashboard customized using a common dashboard framework application.

FIG. 3 is a block diagram illustrating portions of an exemplary computer system implementing a common dashboard framework.

FIG. 4 is a flow chart illustrating a procedure for using a common dashboard framework to create a customized dashboard

FIG. 5 is a block diagram illustrating an example of a supporting data structure for a common dashboard framework.

FIG. 6 illustrates the contents of a “module” object.

FIG. 7 illustrates possible configurations in the “dashboard-config.js” file and in the multiple <module-name>/config.js” files.

FIG. 8 illustrates “Navbar” configuration options.

FIG. 9 illustrates “Group” configuration options.

FIG. 10 illustrates “Subgroup” configurations options.

FIG. 11 illustrates “Toolbar” configuration options.

FIG. 12 illustrates “Toolbar Menu Item” configuration options.

FIG. 13 illustrates “Window Option” configuration options.

FIG. 14 illustrates “Statusbar” configuration options.

FIG. 15 thus illustrates “Application Tools” configuration options.

FIG. 16 illustrates “Tool Configuration” options.

FIG. 17 illustrates “Search Window” configuration options.

FIG. 18 illustrates “Navbar Configuration” options.

FIG. 19 illustrates “Subgroup Bar” configuration options.

### DETAILED DESCRIPTION

### I. Introduction

A mashup is a web display that uses content from more than one source to create a single new visualization. Mashups are known for fast integration and use of a variety of data sources to produce enriched results that were not necessarily envisioned when any of the original raw source data was made available. The present disclosure describes, among other things, a mashup client/server network, which is configured for providing mashups. Such a mashup client/server network provides a mashup on an interface of a mashup client computer that communicates with a mashup server. The mashup server provides desired web services specified by the mashup active on the mashup client.

The web services provide live data through the mashup client/server network. The live data may be used by the mashup without regard to any interface formatting specified by the web services. The mashup then is used to create a mashup dashboard display as a pre-determined visualization. Thus the present disclosure is directed to various inventive concepts and principles embodied in systems, devices, and methods implementing a common dashboard framework that enables the user to customize various components of the mashup dashboard display.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed to provide a common dashboard framework that is easily built and easily deployed. The common dashboard framework allows for dynamic modification and/or adjustment of dashboards. In order to attain a thorough understanding of the novel common dashboard framework disclosed herein, it is first necessary to better understand observed issues in conventional dashboard creation.

### II. Observed Problems of Conventional Dashboards

Dashboards tools are ubiquitous, and many software vendors provide tools and frameworks for building these dashboards. A few traditional portal vendors include open-source Liferay, IBM's WebSphere, and Oracle's WebCenter. Presto by Software AG is a platform that allows for making data sources mashable, mashing, combining or transforming the data in mashups, and exposing the results in many different visualizations in dashboards.

Individual mashup dashboards can be accessed standalone in Presto, but more often dashboards are assembled and deployed to third-party portals. More specifically, mashup dashboards developed in Presto are typically deployed to portals that allow end-users to access the mashup data and visualizations. Typical usage flow involves a customer building the required mashup dashboards in Presto, and then deploying those dashboards one by one to portals using vendor-specific process.

This one-by-one approach to deploying dashboards typically involved creating one or more portal pages on the portal, configuring those pages to point to the mashup dashboards, and setting up appropriate authentication and authorizations for each of those pages. Once these mashup dashboards are deployed, it becomes cumbersome to match the look and feel of dashboards with native portals and even harder to customize or update to meet diverse and evolving needs.

Publishing or displaying mashup dashboards, as mentioned before, requires building and configuring portal pages in vendor portals to embed mashup visualizations. In addition, these portal pages need to be setup with appropriate security privileges so all users have correct access. In Presto, this manual process needs to be repeated for every mashup dashboard created. Furthermore, management of these dashboards, deletion of outdated ones, moving from one taxonomy to another, and restyling to fix the content of a new dashboard will need to be performed manually.

### III. Overview of the Approach

A common dashboard framework has been developed that enables the user to build, assemble and deploy various dashboard configurations based on the user's needs, and to dynamically modify and/or adjust the configurations without many of the manuals steps described above. A common dashboard framework in accordance with the disclosed and claimed embodiments can offer one or more of the following advantages:
Dashboard content and user interface configuration are maintained outside the context of the dashboard application. For example, a list of tabs displayed on the screen is stored outside the application as a preference/configuration. New tabs can be added or deleted by redeploying the configuration.
Sets of related mashup dashboards can be grouped into “modules,” and these modules can inject one or more mashup dashboards into a dashboard container.
The “look and feel” of dashboards can be controlled centrally using themes or by using dashboard configuration properties. Updating a configuration property will alter all dashboards configured in the application.
Security and authorization for the dashboards can now be centrally controlled (for example, by Presto severs) such that additional setup is not required.

### IV. In-Depth Discussion of Common Dashboard Framework

The novel common dashboard framework disclosed herein allows the user to deploy dashboards more efficiently and in a much more tailored and configurable fashion. It provides for a targeted, higher-level user experience and an organized, themed delivery of applications and other products. The framework facilitates portal-like end-user customizations to dashboards.

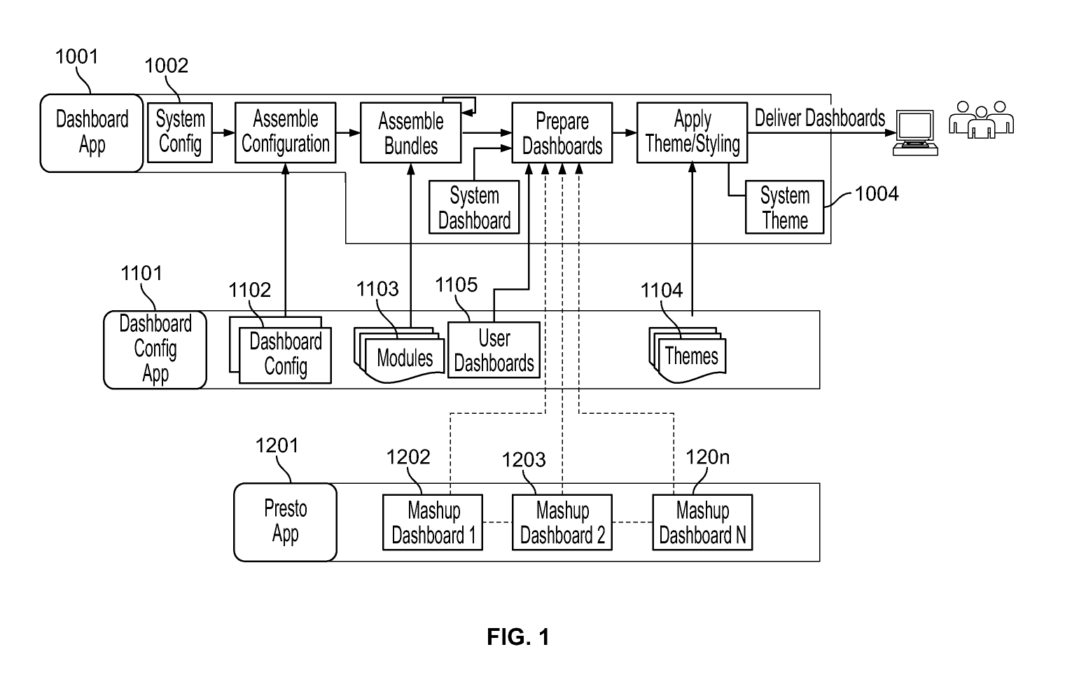

The common dashboard framework disclosed herein allows dashboards to be delivered in a user-driven way. The common dashboard framework enables a user to define configuration files that define how the dashboard should look and act, and what content gets deployed and published within the dashboard. The modules within the dashboard are configurable and extensible with URL accessible groups and subgroups. FIG. 1 below is a block diagram illustrating an overview of the dashboard assembly process using a common dashboard framework

By way of overview, a common dashboard framework assembly process can include a dashboard app 1001, a system config 1002, a system dashboard, a dashboard config app 1101, dashboard config files 1102, modules 1103, user dashboards 1105, themes 1104, a system theme 1004, a Presto App 1201 (representative of an app), and mashup dashboards 1202, 1203 . . . 120n. A dashboard app 1001 is initiated, such as by a user request for a user dashboard 1105 and/or one or more mashup dashboards 1202, 1203 . . . 120n. A configuration for the requested dashboard is assembled from the system configuration 1002 provided by the dashboard app 1001, and the dashboard configuration 1102 for the common dashboard provided by the dashboard config app 1101. A bundle is assembled from modules 1103 to be applied (specified in the system config 1002, the dashboard config 1102, and/or in the modules 1103 themselves) and the assembled configuration for the requested dashboard. The dashboard is prepared from the assembled bundles, a system dashboard, and the requested dashboard (for example, user dashboard 1105, a mashup dashboard 1202, 1203 . . . 120n). Then, the system theme 1004 and the themes 1104 are applied to create the dashboard which is delivered to the user. The dashboard delivered to the user has not only the look and feel and behavior specified by system config 1002, and the system dashboard and the system theme 1004 which the system config 1002 specifies (which will be common to all dashboards according to this embodiment for the same system); but also the look and feel and behavior specified by the dashboard config 1102, the modules 1103 which the dashboard config 1102 and system config 1002 reference, (optionally) the user dashboard 1105, and the themes 1104 which are specified by the dashboard config 1102 (which will be common to all dashboards for the dashboard config app 1101 according to this embodiment even for different systems).

Once a dashboard is created using the definitions that are based on a configuration specification in one or more of the common dashboard framework configuration files (sometimes referred to as “configuration files” or a “configuration file”) 1102, then the dashboard which is delivered to a user will have a certain look and feel that is based on those definitions within the configuration specification (sometimes referred to as a “specification”). The dashboard will also have a certain behavior that is based on those definitions. If a user wants to group certain content together that is defined in the configuration based on the specification, and if the user wants to navigate through the dashboard from one group of content to a sub-group of content within that group of content, then the manner of accomplishing that navigation is defined within the configuration files 1102 and one or more of the dashboard modules 1103.

The common dashboard framework configuration files 1102 include specifications for how a dashboard looks and “behaves” (that is, what happens when a user clicks on, for example, an icon or tab). The types of visualization and “behavior” defined in the configuration file 1102 include 1) the appearance of icons representative of the group of content itself and the subset that is defined within the group when a user navigates to a specific group of content (for example, a specific dashboard); 2) how that dashboard surfaces (whether it shows-up as a tab or a separate window); 3) how the toolbar looks and acts; 4) what exists on the toolbar; and 5) what exists on the status bar.

Every dashboard, here represented by mashup dashboards 1202, 1203 . . . 120n, which is customized using the common dashboard framework has a corresponding configuration artifact. The common dashboard framework allows the user to deploy as many dashboards as desired just by generating a configuration representative of a dashboard that the user wants. All of the visual components of the dashboard can be available as a configuration externally.

There can be numerous files associated with a dashboard and these files can exist outside of the common dashboard framework itself. The dashboard interacts with these outside files and then renders itself in many different ways, depending on what is defined in the common dashboard framework configuration files 1102. For example, a user could have a configuration file that renders a dashboard with several workspaces and apps displayed on the dashboard in particular visual/behavioral theme.

There are at least three areas that define a container in which links to a dashboard can be surfaced. A top horizontal bar is the toolbar. A left vertical bar is the group bar. A bottom horizontal bar is the status bar. Using the information in the common dashboard framework configuration files 1102, the display could include, for example, five buttons on the left side of the display (“group bar”), three buttons on the top of the display (“toolbar”), and two buttons on the bottom of the display (“status bar”).

The common dashboard framework provides areas that contain, organize, and navigate to different content. The space inside the three areas can consist of different windows with tabs. Each tab can link to a different dashboard 1201 for example.

The common dashboard framework thus provides the means and methodology for delivering a dashboard that has already been created. It is a delivery mechanism that uniquely allows for user input to specify the visual and behavioral characteristics of the dashboard 1201. Additionally, users can also create new dashboards using the various configured apps to create highly personalized user dashboards 1105 to meet their individual needs or use. These personalized user dashboards 1105 are user specific and can be made available only to that user.

The common dashboard framework is valuable to corporate users because it allows the businesses to deliver demos, products, etc. in a consistent way so that there is an organization-wide or division-wide standard approach to delivering software. This in turn lowers costs.

The supporting data structure for the common dashboard framework includes a dashboard configuration application 1101 which modifies the dashboard app 1001. The dashboard configuration application 1101 can be updated and modified to configure the dashboard application. The dashboard configuration application 1101 may include, for example, files that define the dashboard (“dashboard-config.js”), the dashboard theme (“dashboard-config.css”), and the various modules (“modules-configjs”).

A list of modules 1103 to be applied is present in a modules-config.js file as the module object. Each module can be defined as an object with a module name. The module name can be the key to accessing the object.

The configurable options are present as a configuration object in both the dashboard-config.js file as well as in the <module-name>/configjs file. Since the dashboard-config.js is common for all of the modules, then the configuration can be kept in this dashboard-config.js file, and the configuration which is specific to each module can be kept in the <module-name>/configjs file for the corresponding module. Generally, the navbar/group/subgroup configuration options can be kept in the <module-name>/configjs, and other configuration options can be contained in the dashboard-config.js file.

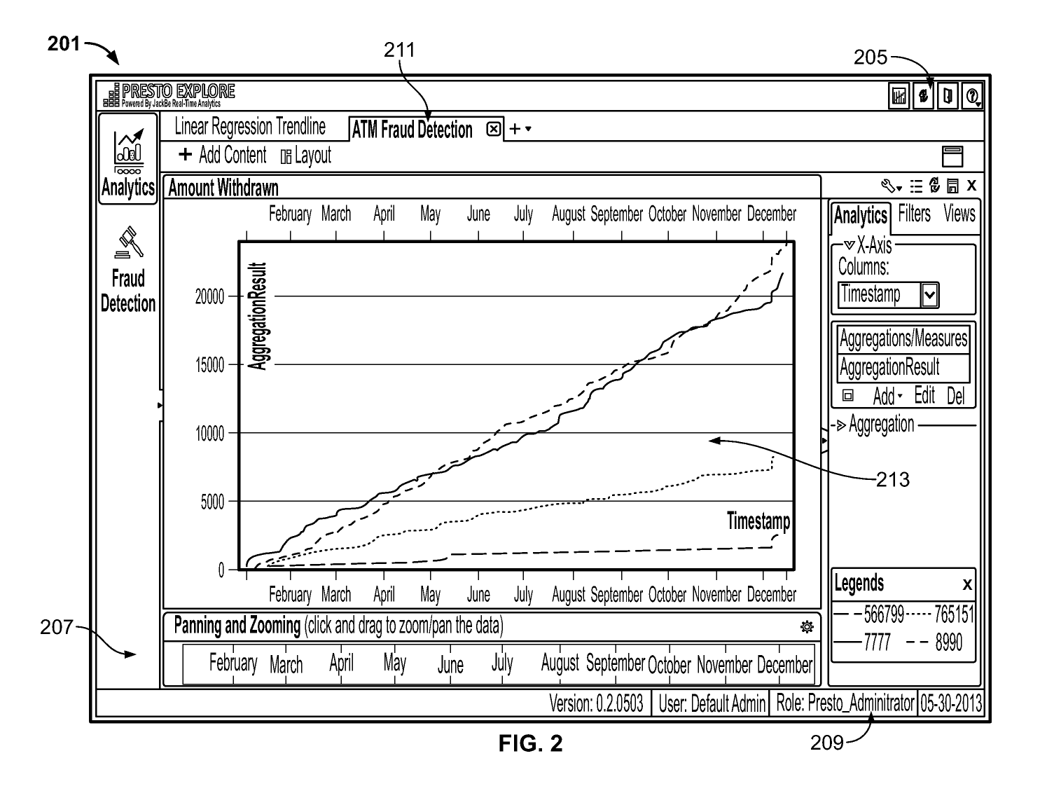

FIG. 2 is a screenshot of an example dashboard customized using a common dashboard framework application in accord with FIG. 1. FIG. 2 shows a dashboard 201 that has been configured using the common dashboard framework. The toolbar 205, the group bar 207, and the status bar 209 have been designated by the user to have specified visual characteristics and behavioral characteristics using configuration files, for example, modules-config.js, dashboard-config.js, and <module-name>/config.js.

In FIG. 2, the dashboard tabs 211 and workspace 213 are designated to look and operate based on user-defined specifications. That is to say, the tabs 211 and workspace 213 are individually defined by the user rather than as part of the more general configuration files. It should be specifically noted that the mashup data rendered in the workspace 213 (which takes the form of a graph with three plots) is merely exemplary. There are of course countless different possible types of mashup data that can be displayed in a workspace 213.

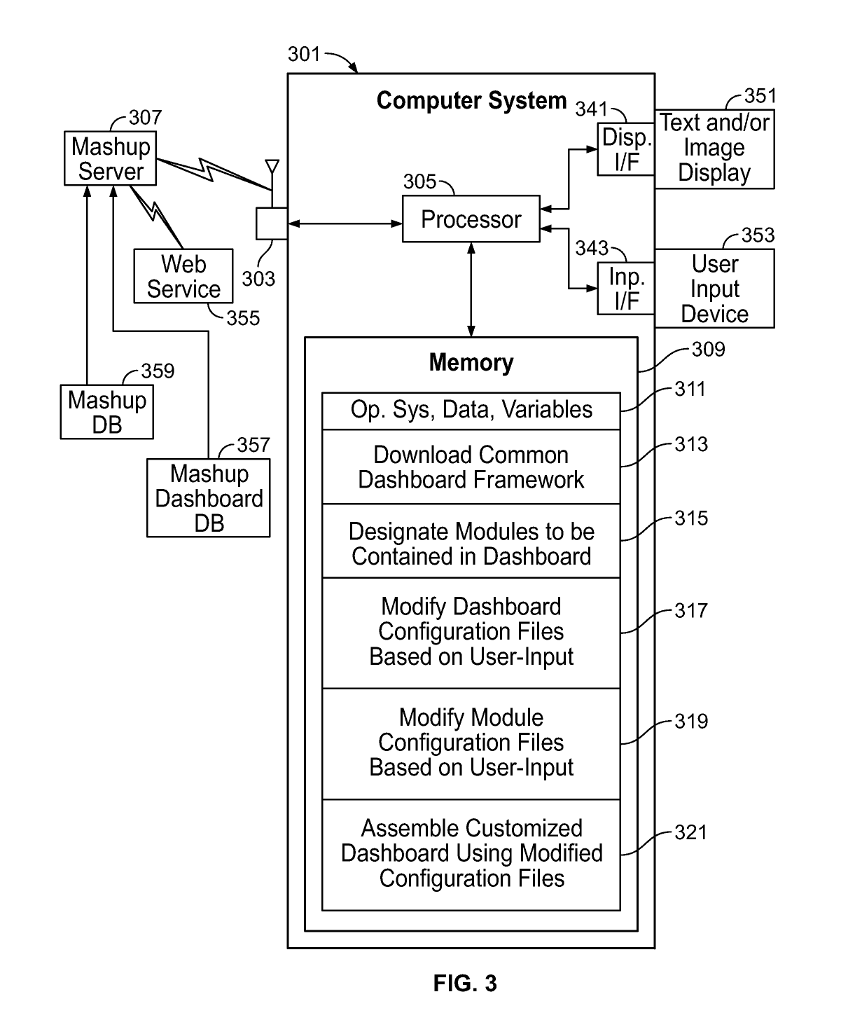

FIG. 3 is a block diagram illustrating portions of an exemplary computer system implementing a common dashboard framework. The computer system 301 may include a communication port and/or transceiver 303 or the like for communication with a mashup server 307, a processor 305, a memory 309, a display interface 341 and a display 351, an optional input interface 343 and a user input device 353 such as a keyboard. The processor 305 may comprise one or more microprocessors and/or one or more digital signal processors.

The memory 309 may be coupled to the processor 305 and may comprise a read-only memory (ROM), a random-access memory (RAM), a programmable ROM (PROM), and/or an electrically erasable read-only memory (EEPROM). The memory 309 may include multiple memory locations for storing, among other things, an operating system, data and variables 311 for programs executed by the processor 305; computer programs for causing the processor to operate in connection with a common dashboard framework through various functions such as downloading a common dashboard framework 313, designating modules to be contained in the dashboard 315, modifying dashboard configuration files based on user input 317, modifying module configuration files based on user-input 319, and assembling a customized dashboard using modified configuration files 321. The computer programs may be stored, for example, in ROM or PROM and may direct the processor 305 in controlling the operation of the computer system 301.

The user may invoke functions accessible through the user input device 353, interfaced with the processor 305, through an input interface 343. The user input device 353 may comprise one or more of various known input devices, such as a keyboard and/or a pointing device, such as a mouse. The keyboard may be supplemented or replaced with a scanner, card reader, or other data input device. The pointing device may be a mouse, touch pad control device, track ball device, or any other type of pointing device. Lastly, the input interface 343 can be a known interface thereof to communicate with the processor 305.

The text and/or image display 351 is representative of a display that may present information to the user by way of a conventional liquid crystal display (LCD) or other visual display, and/or by way of a conventional audible device for playing out audible messages. The display interface 341 can be a known interface thereof to communicate between the processor 305 and the display 351. Responsive to signaling from the user input device 353, in accordance with instructions stored in memory 309, or automatically upon receipt of certain information via the communication port and/or transceiver 303, the processor 305 may direct the execution of the stored programs.

The mashup server 307 can access a mashup database 359, on which mashups can be stored (according to known techniques), and a mashup dashboard database 357 on which mashup dashboards can be stored. Although the present example illustrates separate databases for the mashup dashboards 357 and the mashups 359, it should be understood that it is well within the skill of the ordinary practitioner to store mashups and mashup dashboards in a single server

FIG. 3 is described in connection with logical groupings of functions or resources. One or more of these logical groupings may be omitted from one or more embodiments. Likewise, functions may be grouped differently, combined, or augmented without parting from the scope. Similarly the present description may describe various databases or collections of data and information. One or more groupings of the data or information may be omitted, distributed, combined, or augmented, or provided locally and/or remotely without departing from the overall scope of the disclosed and claimed embodiments.

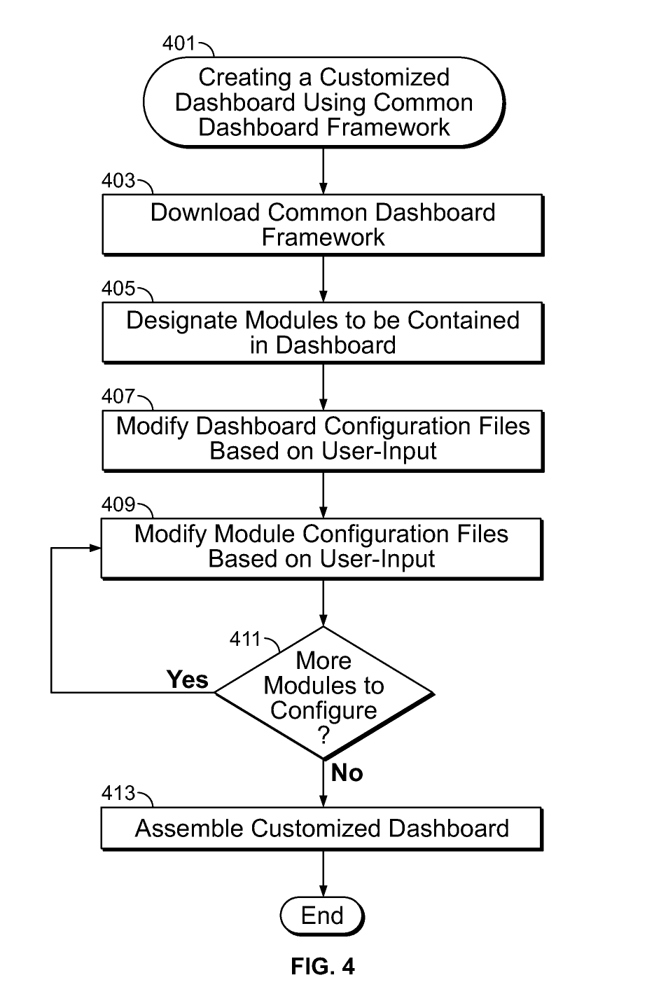

FIG. 4 is a flow chart illustrating a procedure 401 for using a common dashboard framework to create a customized dashboard. The procedure 401 includes downloading 403 a common dashboard framework builder so that the user can create new properties files, designating 405 modules to be contained in the dashboard, modifying 407 dashboard configuration files based on user-input, and modifying 409 module configuration files based on user-input.

The process further includes determining 411 whether there are more modules to configure. If there are more modules to configure, then step 409 is repeated. If there are not more modules to configure, then the customized dashboard is assembled 413 using the configured dashboard and the configured modules. It should be noted that a single command may be executed to assemble the dashboard.

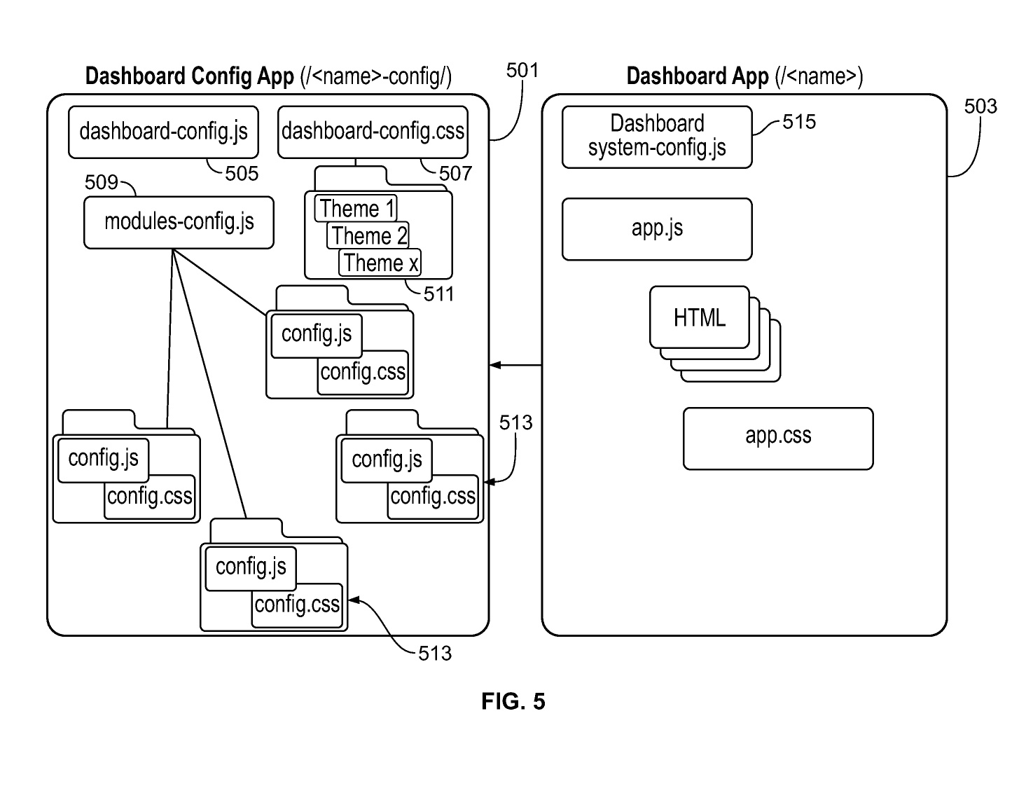

FIG. 5 is a block diagram illustrating an example of the supporting data structure for the common dashboard framework. Dashboards created with a common dashboard framework have two components: a Dashboard App 503 and a Dashboard Config App 501. The separation of the Dashboard App 503 and the Dashboard Config App 501 allows for easy maintenance and upgrading of created dashboards. The Dashboard Config App 501 is used for configuring/altering the contents of the dashboard. The Dashboard App 503 contains all the software required for executing the dashboard.

The Dashboard Config App 501 includes three configuration files: “dashboard-config.js” 505, “dashboard-config.css” 507, and “modules-config.js” 509. The “dashboard-config.css” 507 file includes a theme folder 511 which enables the user to select a dashboard theme. The files in the Dashboard Config App 501 control the contents of the dashboard such as, for example, the group bar, the toolbar, and the status bar.

The Dashboard App 503 includes all software required to assemble and build (i.e., execute) the dashboard including a “system-config.js” 515 file. This file defines all the basic properties of the dashboard. All properties defined in this file can be reconfigured as required by the “dashboard-config.js” file 505 to address any inconsistencies.

The supporting data structure for the common dashboard framework must also provide for modules. There are several relevant points:
The Dashboard Config App 501 typically contains one or mode modules 513 that are defined in the “modules-config.js” 509 file.
Modules can be used to group contents coming from different teams and/or departments and/or groups.
Modules define one or more tabs to be displayed inside the CDF dashboards
A module can be easily turned on/off, allowing you to take down certain sections of the dashboard
Modules map to a button on a left navigation bar
Each module's “config.js” file defines what mashup workspaces should be used.
Each module's “config.css” file allows for control and/or customization and/or override of the look and feel and styling of the dashboard

### V. Examples of Dashboard Configuration Files

The following example definitions of modules, dashboard configurations, module configurations, navbars, groups, subgroups, toolbars, toolbar menu items, window options, status bars, application tools, tool configurations, search windows, navbar configurations, and subgroup bars are provided to illustrate an embodiment, without intending to limit embodiments to those illustrated herein. Furthermore, the specific property names, types, suggested values, and descriptions which are provided are not intended to be limiting, but are intended to provide the example embodiment which suggests additional embodiments. Other embodiments suggested by the description herein may use different and/or additional files and file names, data types, data values, and so on, related to and/or evolved from combinations of some or all of those which are suggested herein.

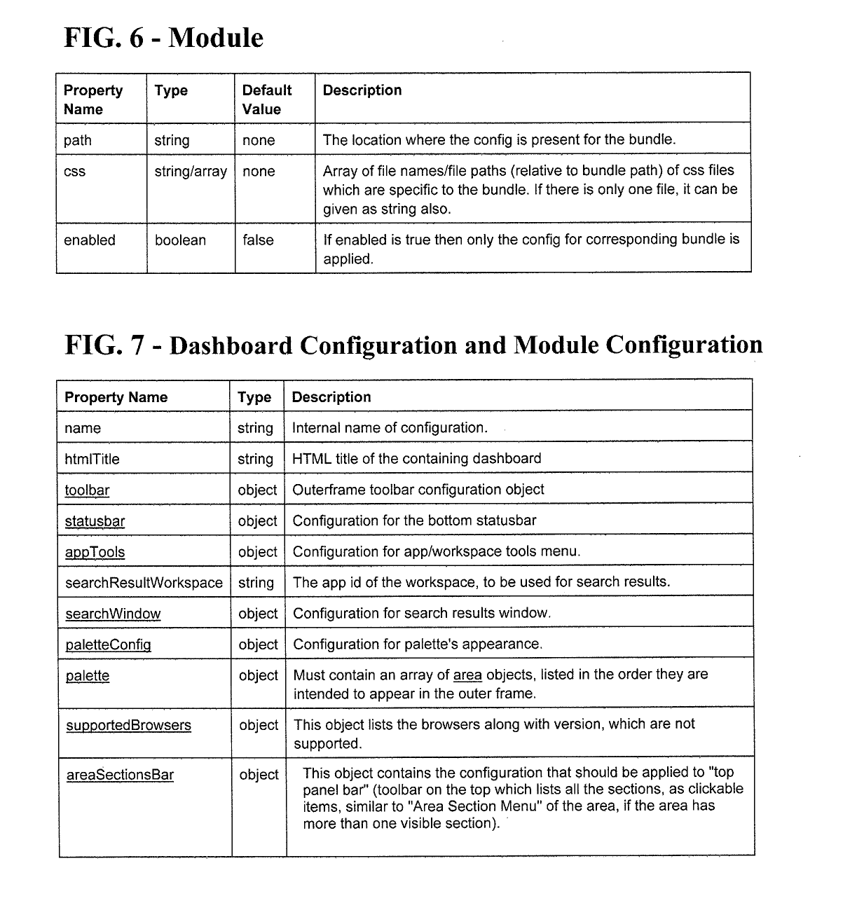

FIGS. 6-19 are examples of dashboard configuration files and their respective contents, for use with the common dashboard framework based on the foregoing principles. As mentioned above, the three primary dashboard configuration files are “modules-config.js”, “dashboard-config.js”, and “<module-name>/configjs.” FIG. 6 illustrates the contents of a “module” object in the module file “modules-config.js.”

FIGS. 7-19 illustrate various configuration options in the “dashboard-config.js” file and in the multiple <module-name>/configjs” files. Since the “dashboard-config.js” file is common for all the modules, any configuration which is common to all modules should be kept in the “dashboard-config.js” file. Any configuration which is specific to each module should be kept in the “<module-name>/config.js” file for the respective module. FIG. 7 thus illustrates possible configurations in the “dashboard-config.js” file and in the multiple <module-name>/configjs” files.

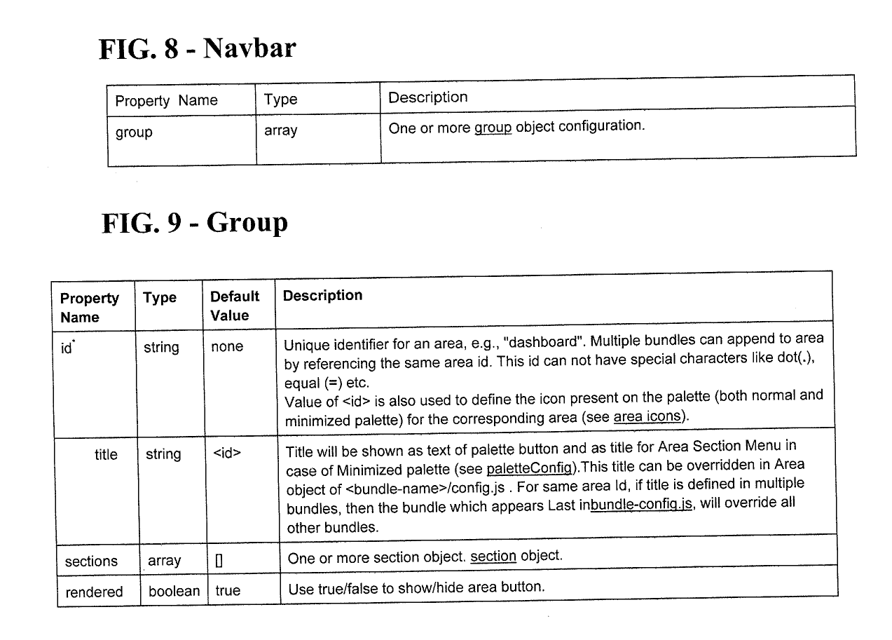

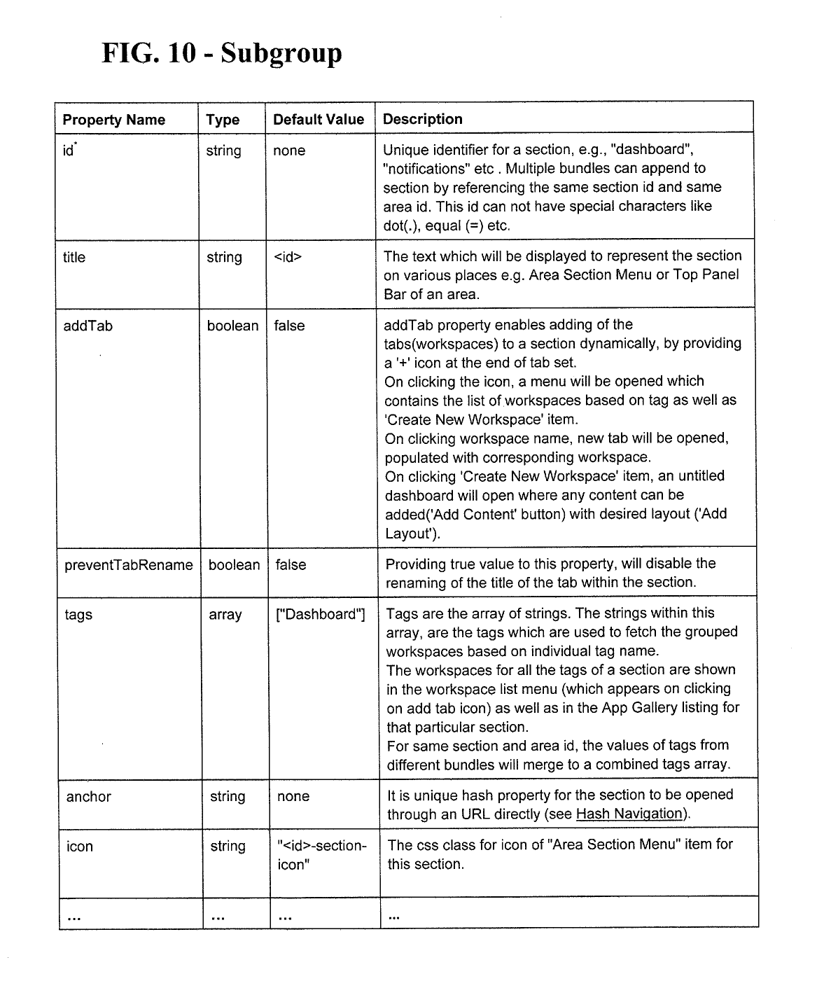

In general, the “Navbar”, “Group”, and “Subgroup” configurations should be kept in respective “<module-name>/config.js” files, and the remaining configuration options should be kept in the “dashboard-config.js.” file. FIG. 8 illustrates the “Navbar” configuration which is stored in respective “<module-name>/config.js” files. FIG. 9 illustrates the “Group” configuration options which are stored in respective “<module-name>/config.js” files. FIG. 10 illustrates “Subgroup” configurations options which are stored in respective “<module-name>/config.js” files. It should be noted that not all possible subgroup configurations are shown in FIG. 10, as indicated by “ . . . ” symbols in the table. Rather, the listed subgroup configurations are simply exemplary.

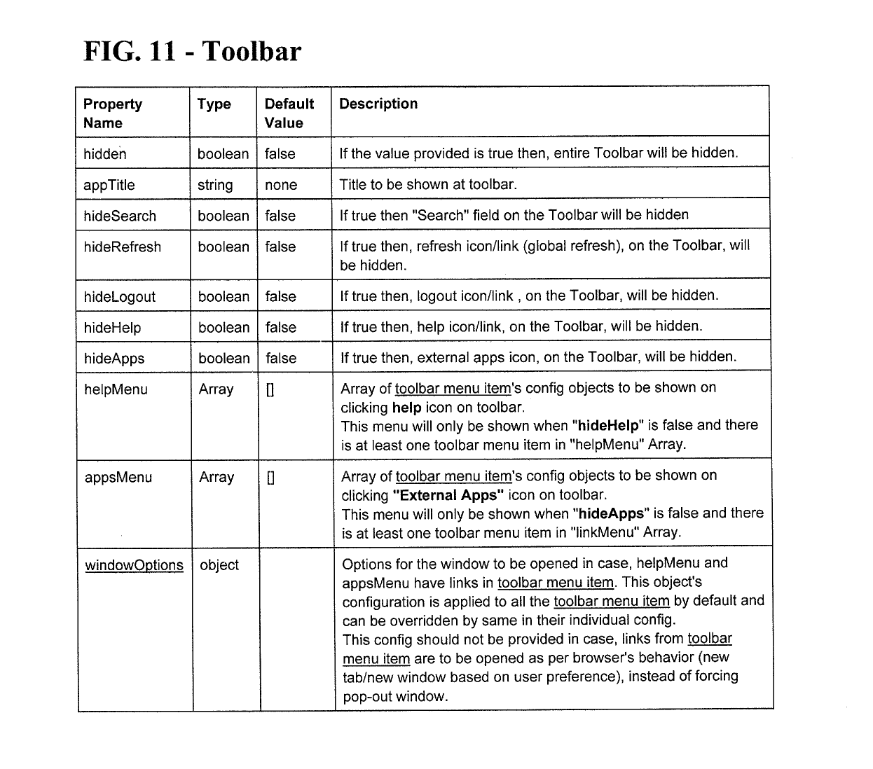

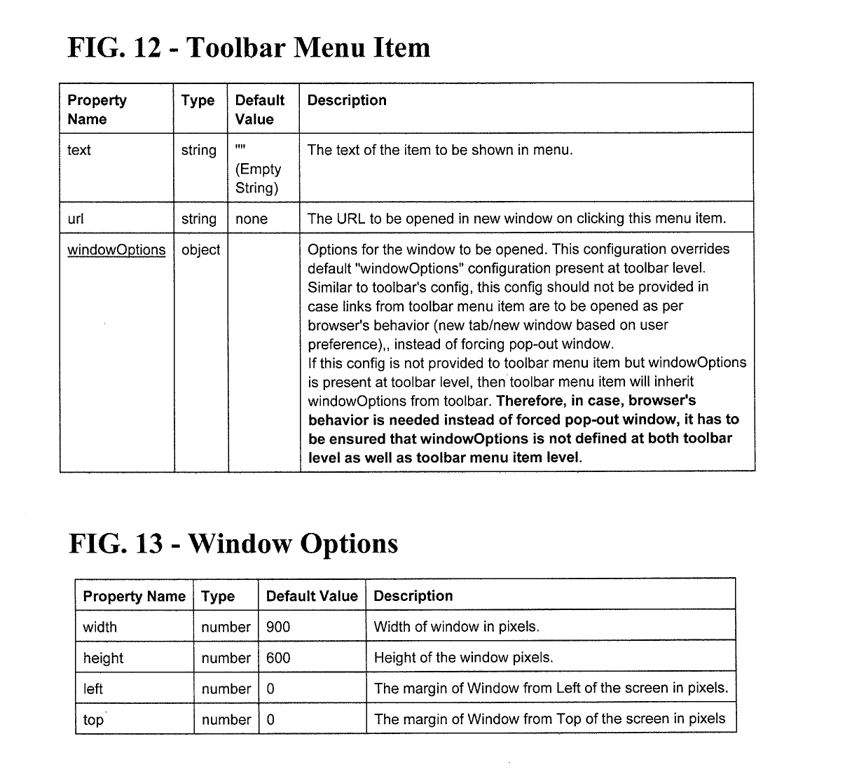

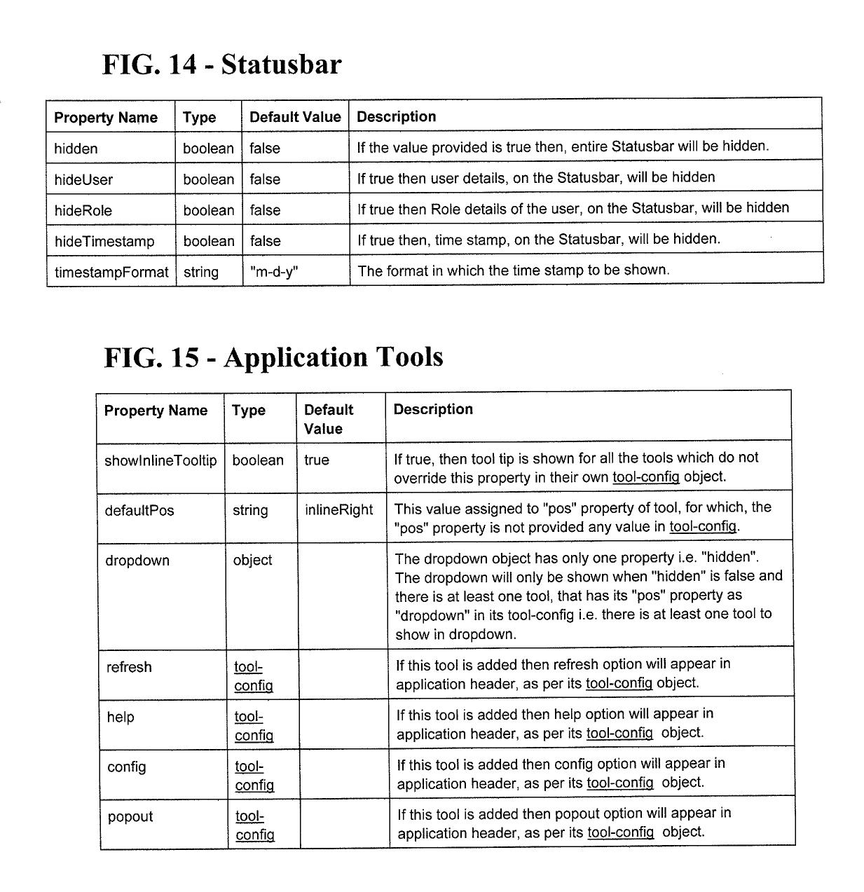

FIG. 11 illustrates the “Toolbar” configuration options that are stored in the “dashboard-config.js” file. FIG. 12 illustrates the “Toolbar Menu Item” configuration options that are stored in “dashboard-config.js” file. FIG. 13 illustrates the “Window Option” configurations that are stored in the “dashboard-config.js” file. FIG. 14 illustrates the “Statusbar” configuration options that are stored in the “dashboard-config.js” file.

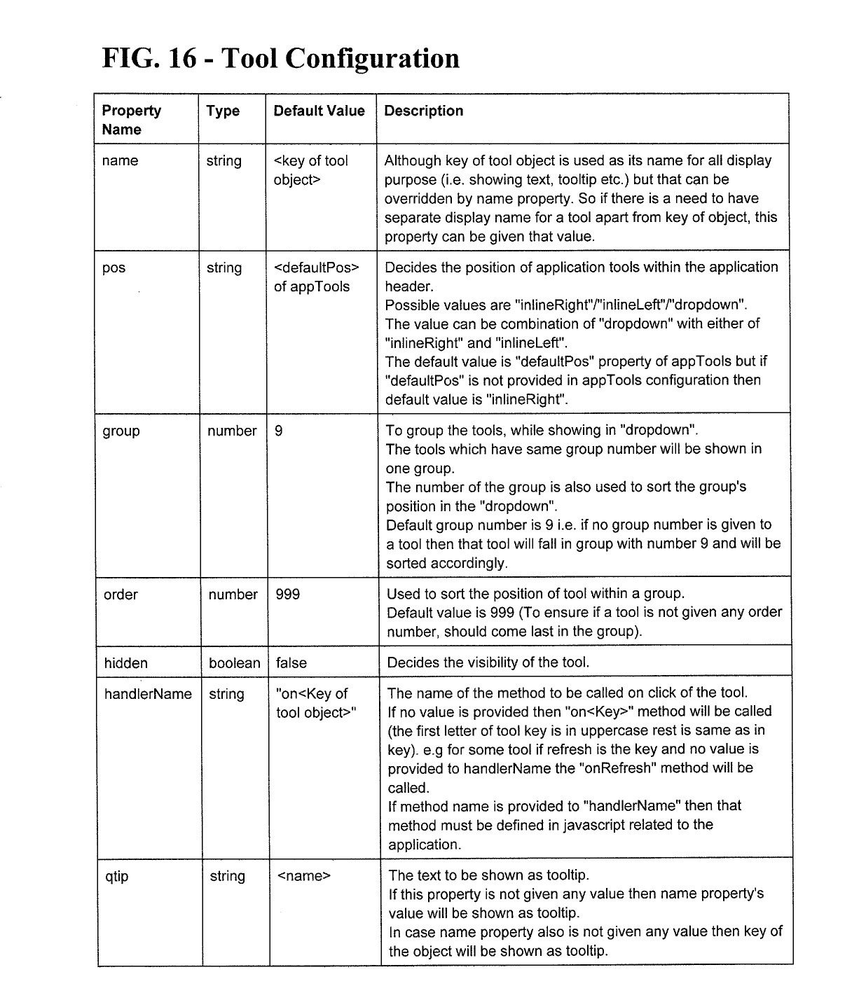

The next drawing reflects configuration objects that determine the behavior/appearance of application tools such as help, refresh, configure, and the like. FIG. 15 thus illustrates the “Application Tools” options that are stored in the “dashboard-config.js” file. FIG. 16 illustrates the “Tool Configuration” options that determine tools shown in an application header. The “Tool Configuration” options are stored in the “dashboard-config.js” file.

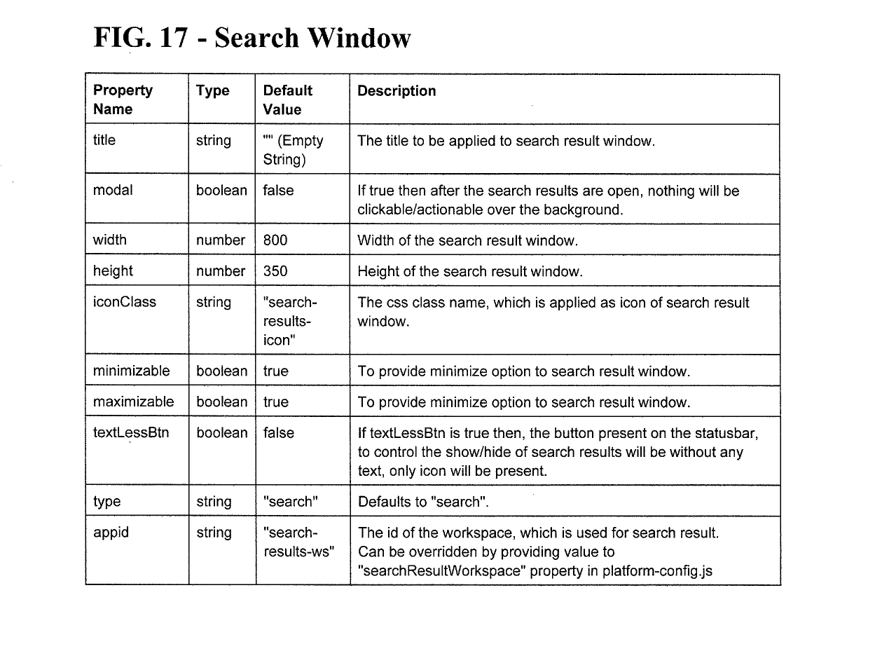

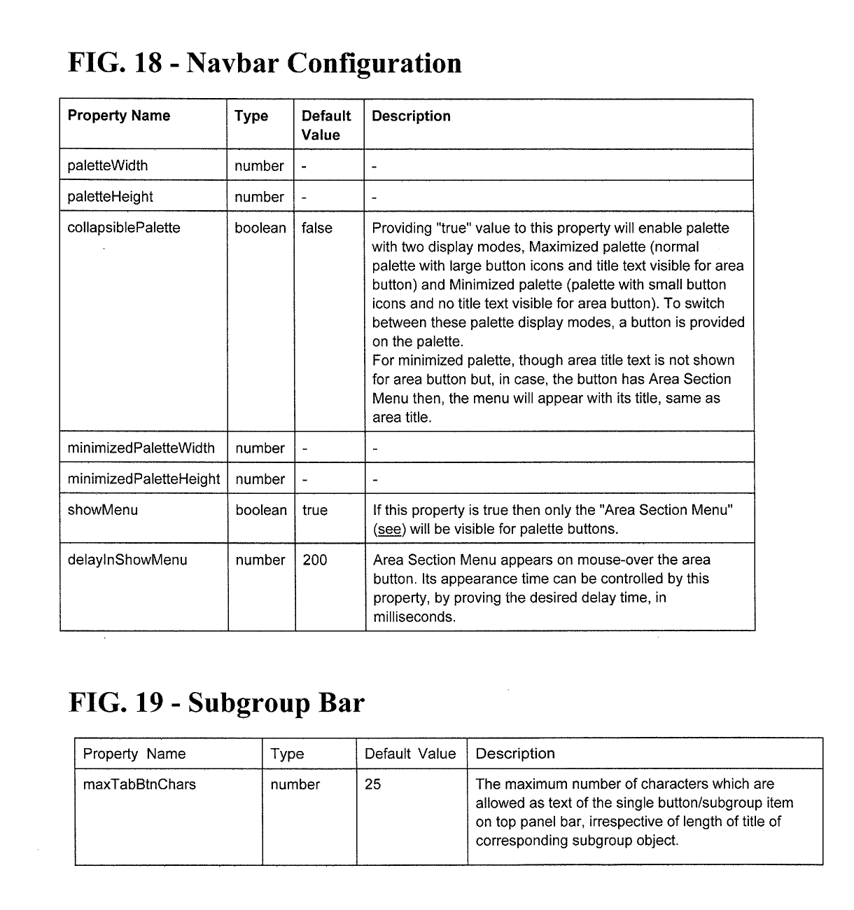

FIG. 17 illustrates the “Search Window” configuration options that are stored in the “dashboard-config.js” file. FIG. 18 illustrates the “Navbar Configuration” configuration options that are stored in respective <module-name>/configjs” files. Lastly, FIG. 19 illustrates the “Subgroup Bar” configuration options that are stored in the respective <module-name>/configjs” files.

### VI. Definitions

The claims may use the following terms, which are defined to have the following meanings for the purpose of the claims herein. Other definitions may be specified in this document.

The term “computer system” as used herein denotes a device sometimes referred to as a computer, laptop, main frame computer, personal computer, personal digital assistant, personal assignment pad, notebook computer, tablet computer, notepad computer, smart phone with embedded processor, or equivalents thereof. As one example, the computer system may be a general purpose computer, or a specially programmed special purpose computer. It may be implemented as a distributed computer system rather than a single computer. Similarly, a communications link may be World Wide Web, a modem over a POTS line, data links, and/or any other wired or wireless method of communicating between computers and/or users. Moreover, the processing could be controlled by a software program on one or more computer system or processors, or could even be partially or wholly implemented in hardware.

The term “communication networks” used herein denotes those that transmit information in packets, for example, those known as packet switching networks that transmit data in the form of packets, where messages can be packetized and routed over network infrastructure devices to a destination. Such networks include, by way of example, the Internet, intranets, local area networks (LAN), wireless LANs (WLAN), wide area networks (WAN), cellular telephone networks, general packet radio service (GPRS) services, GSM (global system for mobile communications) cellular network, and others, and can be supported by networking protocols such as TCP/IP (Transmission Control Protocol/Internet Protocol) and UDP/UP (Universal Datagram Protocol/Universal Protocol) and/or other protocol structures, and variants and evolutions thereof. Such networks can provide wireless communications capability and/or utilize wireline connections such as cable and/or a connector, or similar. Any appropriate communication protocol may be used.

The term “app” is short for “application,” and denotes a computer executable software program that performs a function to benefit the user. The terms “app” and “application” may be used interchangeably. The term “app” is used to refer to discrete applications that provide a single function and a simple user interface. The term “app” is sometimes used to refer to programs such as GoogleMaps, for example. An “app” is a way to visualize a mashup. An “app” is different from an operating system that runs the computer.

For the purpose of this patent application, a “mashup” is defined as a software application that combines pre-existing components from one or more information-providing services into a single tool which can comprise a server-side and a client-side application, the components used by the mash-up being visually presented to a user on a display at the client-side in a manner which is different from the pre-determined presentation of the information-providing service. A mashup is configured in accordance with standards such as Enterprise Mashup Markup Language (“EMML”), XML interchanged as REST or Web Services, RSS, Atom, and other evolutions and variations of mashup standards. A mashup is to be distinguished from a portal in which content is presented side-by-side in the manner which is the same as the pre-determined presentation of the information-providing service. The designation “component” as used in this paragraph refers to data which is retrieved by a mashup in real-time from an information-providing service. A mashup is frequently made by access to open APIs and other data sources to produce results that were not the original reason for producing the raw source data. An example of a mashup is the use of cartographic data from Google Maps to add location information to real estate data, thereby creating a new and distinct Web service that was not originally provided by either source.

The term “service”, sometimes referred to herein as an “information-providing service”, is used herein expressly to refer to an information-providing service that provides data from a server in a visual presentation on a display to a user, typically an application programming interface (API) or web API that can be accessed over a computer network and executed on a remote system hosting the requested services, in accordance with Extensible Markup Language messages that follow the Simple Object Access Protocol (SOAP) standard such as SOAP Version 1.2 specification, Web Services Description Language (WSDL) such as Web Services Description Language Version 2.0 Specification, Representational State Transfer (REST) constraints, and variations and evolutions thereof. An example of a service is Google Maps, a Web service or an RSS feed.

The phrase “automatically without user intervention” if used in a claim is defined to mean that the particular step occurs after the step is initiated until limitations recited in the step are finished without requiring a user to provide input to a processor.

### VII. Miscellaneous

The discussion heretofore has introduced particular examples. However, the principles gleaned from the examples apply in various realizations and other examples. Naturally, the relevant data may differ, as appropriate. Certain examples may have been described herein as available by a provider to a single user at a single site. However, it should be understood that the above described system, device, and/or method may be used by numerous users over distributed systems, if so preferred.

The detailed descriptions, which appear herein, may be presented in terms of program procedures executed on a computer or a network of computers. These procedural descriptions and representations herein are the means used by those skilled in the art to most effectively convey the substance of their work to others skilled in the art.

Further, an embodiment has been discussed in certain examples as if it is made available by a provider to a single customer with a single site. An embodiment may be used by numerous users, if preferred, and the users can be at one or more sites.

A computer-readable storage medium is tangible and non-transitory; a computer-readable storage medium can be any of the memory or disks, such as those examples described herein, or other removable or fixed storage medium.

One or more displays for the system may be developed in connection with HTML display format. Although HTML is the preferred display format, it is possible to utilize alternative display formats for interacting with a user and obtaining user instructions.

The system used in connection with various embodiments may rely on the integration of various components including, as appropriate and/or if desired, hardware and software servers, applications software, database engines, server area networks, firewall and SSL security, production back-up systems, and/or applications interface software. The configuration may be, preferably, network-based and optionally utilizes the Internet as an exemplary interface with the user for information delivery.

The various databases may be in, for example, a relational database format, but other standard data formats may also be used. Windows 7, for example, may be used, but other standard operating systems may also be used. Optionally, the various databases include a conversion system capable of receiving data in various standard formats.

The foregoing detailed description includes many specific details. The inclusion of such detail is for the purpose of illustration only and should not be understood to limit the invention. In addition, features in one embodiment may be combined with features in other embodiments of the invention. Various changes may be made without departing from the scope of the invention as defined in the following claims.

A procedure is generally conceived to be a self-consistent sequence of steps leading to a desired result. These steps are those requiring physical manipulations of physical quantities. Usually, though not necessarily, these quantities take the form of electrical or magnetic signals capable of being stored on non-transitory computer-readable media, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms such as adding or comparing, which are commonly associated with mental operations performed by a human operator. While the discussion herein may contemplate the use of an operator, a human operator is not necessary, or desirable in most cases, to perform the actual functions described herein; the operations are machine operations.

Various computers or computer systems may be programmed with programs written in accordance with the teachings herein, or it may prove more convenient to construct a more specialized apparatus to perform the required method steps. The required structure for a variety of these machines will be apparent from the description given herein.

Terms as used herein are intended to be interpreted as understood to one of skill in the art of interface design and mashups, but if not thus interpretable, then in the art of data processing and/or computer science, instead of as interpreted by a more general dictionary.

Furthermore, the networks of interest for communicating between computers onto which some embodiments may be distributed include by way of example but not limitation data and/or packet communications networks, which can provide wireless communications capability and/or utilize wireline connections such as cable and/or a connector, or similar. Any appropriate communication protocol may be used.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the teachings herein. The embodiments described above were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An apparatus, comprising:
a memory; and
a processor cooperatively operable with the memory, and programmed to, based on instructions stored in the memory:
provide a common dashboard framework, the common dashboard framework including
dashboard configuration data that specifies a configuration of dashboard content and a user interface configuration for a mashup dashboard, wherein the dashboard content and the user interface configuration control visual and behavioral characteristics of the mashup dashboard that are independent of mashup data, and wherein the visual and behavioral characteristics are controlled to provide a same look and feel for different mashups, and different dashboard configuration data provides a different look and feel for the different mashups, and
dashboard module data that specifies whether the mashup dashboard is associated with a pre-defined group of mashup dashboards, such that a configuration of the mashup dashboard further reflects the pre-defined group of mashup dashboards when the mashup dashboard is associated with the pre-defined group of mashup dashboards; and
assemble the mashup dashboard based on the dashboard configuration data, the dashboard module data, and a workspace for the mashup data to provide a dashboard for delivery and presentation to a user.

2. The apparatus according to claim 1, wherein
the processor is further configured to accept an input from a user via an input interface which provides the dashboard configuration data or changes the dashboard configuration data.

3. The apparatus according to claim 1, wherein
the visual and behavioral characteristics of the mashup dashboard include a toolbar and a status bar which are controlled to be the same to provide a same look and feel for the different mashups.

4. The apparatus according to claim 3, wherein
when the mashup dashboard is associated with the pre-defined group of mashup dashboards, the configuration of the mashup dashboard further reflecting the pre-defined group of mashup dashboards includes a group toolbar which controls the visual and behavioral characteristics of a toolbar to be common to all mashups dashboards in the pre-defined group.

5. The apparatus according to claim 1, wherein
the dashboard configuration data further includes theme data that further specifies the configuration of the mashup dashboard to include a theme of the mashup dashboard, wherein the theme of the mashup dashboard is controlled to provide a same theme for different mashups, and a different theme provides a different them for the different mashups, and

6. The apparatus according to claim 1, wherein
the configuration data specifying the visual and behavioral characteristics of the mashup dashboard is stored as an artifact that is portable.

7. A method, implemented in an apparatus including a memory and a processor that are cooperatively operable with each other, comprising:
providing, by the processor a common dashboard framework, the common dashboard framework including
dashboard configuration data that specifies a configuration of dashboard content and a user interface configuration for a mashup dashboard, wherein the dashboard content and the user interface configuration control visual and behavioral characteristics of the mashup dashboard that are independent of mashup data, and wherein the visual and behavioral characteristics are controlled to provide a same look and feel for different mashups, and different dashboard configuration data provides a different look and feel for the different mashups, and
dashboard module data that specifies whether the mashup dashboard is associated with a pre-defined group of mashup dashboards, such that a configuration of the mashup dashboard further reflects the pre-defined group of mashup dashboards when the mashup dashboard is associated with the pre-defined group of mashup dashboards; and
assembling, by the processor, the mashup dashboard based on the dashboard configuration data, the dashboard module data, and a workspace for the mashup data to provide a dashboard for delivery and presentation to a user.

8. The method according to claim 7, further comprising:
accepting, by the processor, an input from a user via an input interface which provides the dashboard configuration data or changes the dashboard configuration data.

9. The method according to claim 7, wherein
the visual and behavioral characteristics of the mashup dashboard include a toolbar and a status bar which are controlled to be the same to provide a same look and feel for the different mashups.

10. The method according to claim 9, wherein
when the mashup dashboard is associated with the pre-defined group of mashup dashboards, the configuration of the mashup dashboard further reflecting the pre-defined group of mashup dashboards includes a group toolbar which controls the visual and behavioral characteristics of a toolbar to be common to all mashups dashboards in the pre-defined group.

11. The method according to claim 7, wherein
the dashboard configuration data further includes theme data that further specifies the configuration of the mashup dashboard to include a theme of the mashup dashboard, wherein the theme of the mashup dashboard is controlled to provide a same theme for different mashups, and a different theme provides a different them for the different mashups, and

12. The method according to claim 7, wherein
the configuration data specifying the visual and behavioral characteristics of the mashup dashboard is stored as an artifact that is portable.

13. A non-transitory, computer-readable storage medium with instructions stored thereon, which when executed by a processor in an apparatus, the processor being cooperatively operable with a memory in the apparatus, results in the processor performing the following method:
providing a common dashboard framework, the common dashboard framework including
dashboard configuration data that specifies a configuration of dashboard content and a user interface configuration for a mashup dashboard, wherein the dashboard content and the user interface configuration control visual and behavioral characteristics of the mashup dashboard that are independent of mashup data, and wherein the visual and behavioral characteristics are controlled to provide a same look and feel for different mashups, and different dashboard configuration data provides a different look and feel for the different mashups, and
dashboard module data that specifies whether the mashup dashboard is associated with a pre-defined group of mashup dashboards, such that a configuration of the mashup dashboard further reflects the pre-defined group of mashup dashboards when the mashup dashboard is associated with the pre-defined group of mashup dashboards; and
assembling the mashup dashboard based on the dashboard configuration data, the dashboard module data, and a workspace for the mashup data to provide a dashboard for delivery and presentation to a user.

14. The non-transitory storage medium according to claim 13, wherein the method further comprises:
accepting an input from a user via an input interface which provides the dashboard configuration data or changes the dashboard configuration data.

15. The non-transitory storage medium according to claim 13, wherein
the visual and behavioral characteristics of the mashup dashboard include a toolbar and a status bar which are controlled to be the same to provide a same look and feel for the different mashups.

16. The non-transitory storage medium according to claim 15, wherein
when the mashup dashboard is associated with the pre-defined group of mashup dashboards, the configuration of the mashup dashboard further reflecting the pre-defined group of mashup dashboards includes a group toolbar which controls the visual and behavioral characteristics of a toolbar to be common to all mashups dashboards in the pre-defined group.

17. The non-transitory storage medium according to claim 13, wherein
the dashboard configuration data further includes theme data that further specifies the configuration of the mashup dashboard to include a theme of the mashup dashboard, wherein the theme of the mashup dashboard is controlled to provide a same theme for different mashups, and a different theme provides a different them for the different mashups, and

18. The non-transitory storage medium according to claim 13, wherein
the configuration data specifying the visual and behavioral characteristics of the mashup dashboard is stored as an artifact that is portable.
